(19) United States
(12) Patent Application Publication
(10) Pub. No.: US 2008/0042567 A1
(43) Pub. Date: Feb. 21, 2008

(54) PLASMA DISPLAY PANEL

(76) Inventors: Hong Rae CHA, Seoul (KR); Ji Hoon Sohn, Seoul (KR); Sam Je Cho, Seoul (KR); Woo Sung Jang, Seoul (KR); Woon Seo Shin, Seoul (KR)

Correspondence Address: KED & ASSOCIATES, LLP, P.O. Box 221200, Chantilly, VA, 20153-1200, US

(21) Appl. No.: 11/836,342

(22) Filed: Aug. 9, 2007

(30) Foreign Application Priority Data
Aug. 18, 2006 (KR) 10-2006-00078263

(51) Int. Cl. H01J 17/49

(52) U.S. Cl. 313/582

(57) ABSTRACT

A plasma display panel (PDP) is provided. The PDP includes an upper substrate on which first and second electrodes and a dielectric layer are disposed; and a lower substrate on which a third electrode is formed. The dielectric layer includes a base unit and a plurality of pattern units which are formed in the base unit. In short, a plurality of external light shield patterns for shielding external light are formed in an upper substrate or in an upper dielectric layer of a PDP, and thus, it is possible to effectively realize black images and improve the bright room contrast of a PDP.

This application claims priority from Korean Patent Application No. 10-2006-0078263 filed on Aug. 18, 2006 in the Korean Intellectual Property Office, the disclosure of which is incorporated herein by reference in its entirety.

### BACKGROUND OF THE INVENTION

1. Field of the Invention

The present invention relates to a plasma display panel (PDP), and more particularly, to a PDP shielding external light incident upon a plasma display panel (PDP) so that the bright room contrast of the PDP can be improved, and that the luminance of the PDP can be uniformly maintained.

2. Description of the Related Art

In general, plasma display panels (PDPs) display images including text and graphic images by applying a predetermined voltage to a number of electrodes installed in a discharge space to cause a gas discharge and then exciting phosphors with the aid of plasma that is generated as a result of the gas discharge. PDPs are easy to manufacture as large-dimension, light, and thin flat displays. In addition, PDPs can provide wide vertical and horizontal viewing angles, full colors and high luminance.

In the meantime, external light incident upon a PDP may be reflected by an entire surface of the PDP due to white phosphors that are exposed on a lower substrate of the PDP. For this reason, PDPs may mistakenly recognize and realize black images as being brighter than they actually are, thereby causing contrast degradation.

### SUMMARY OF THE INVENTION

The present invention provides a plasma display panel (PDP) which can improve bright room contrast and uniformly maintain luminance.

According to an aspect of the present invention, there is provided a PDP, including an upper substrate on which first and second electrodes and a dielectric layer are disposed and a lower substrate on which a third electrode is formed. The dielectric layer includes a base unit and a plurality of pattern units which are formed in the base unit. A refractive index of the pattern units may be 0.3-0.99 times higher than a refractive index of the base unit. The pattern units may contain light absorption particles. The base unit may include a dielectric material. The pattern units may include a black ceramic material.

According to another aspect of the present invention, there is provided a PDP, including an upper substrate; first and second electrodes which are disposed on the upper substrate; a lower substrate; and a third electrode which is disposed on the lower substrate. The upper substrate includes a base unit and a plurality of pattern units which are formed in the base unit. A refractive index of the pattern units may be 0.3-0.99 times higher than a refractive index of the base unit. The pattern units may contain light absorption particles. The base unit may include a dielectric material. The pattern units may include a black ceramic material.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view of a plasma display panel (PDP) according to an embodiment of the present invention;

FIG. 2 is a cross-sectional view of a PDP having a plurality of external light shield patterns, according to an embodiment of the present invention;

FIG. 3 is a cross-sectional view of a PDP having a plurality of external light shield patterns, according to another embodiment of the present invention;

FIG. 4A is a cross-sectional view of a plurality of external light shield patterns that are formed in a PDP, according to an embodiment of the present invention;

FIG. 4B is a plan view of a plurality of external light shield patterns that are formed in a PDP, according to an embodiment of the present invention; and

FIGS. 5A through 5F are cross-sectional views of various shapes of external light shield patterns that can be formed in a PDP, according to embodiments of the present invention.

### DETAILED DESCRIPTION OF THE INVENTION

The present invention will hereinafter be described in detail with reference to the accompanying drawings in which exemplary embodiments of the invention are shown.

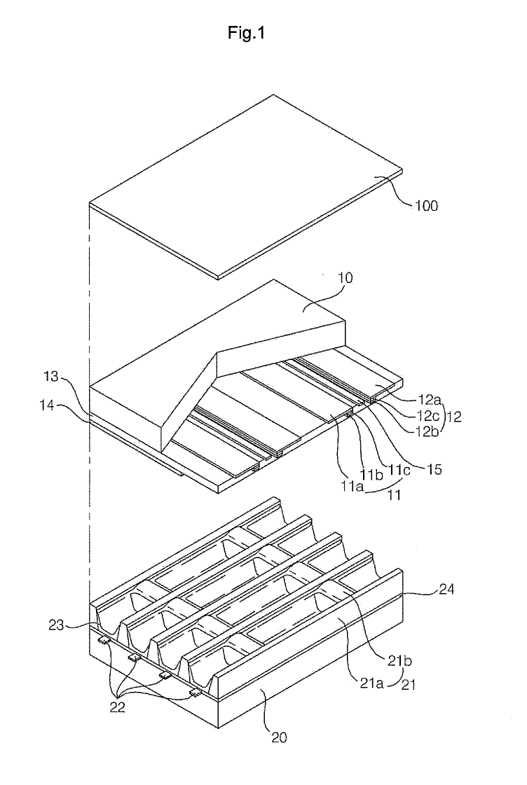

FIG. 1 is a perspective view of a plasma display panel (PDP) according to an embodiment of the present invention. Referring to FIG. 1, the PDP includes an upper substrate 10, a plurality of electrode pairs which are formed on the upper substrate 10 and consist of a scan electrode 11 and a sustain electrode 12 each; a lower substrate 20; and a plurality of address electrodes 22 which are formed on the lower substrate 20.

Each of the electrode pairs includes transparent electrodes 11a and 12a and bus electrodes 11b and 12b. The transparent electrodes 11a and 12a maybe formed of indium-tin-oxide (ITO). The bus electrodes 11b and 12b may be formed of a metal such as silver (Ag) or cliromium (Cr) or may be comprised of a stack of chromium/copper/cliromium (Cr/Cu/Cr) or a stack of chromiuln/aluminium/chromium (Cr/Al/Cr). The bus electrodes 11b and 12b are respectively formed on the transparent electrodes 11a and 12a and reduce a voltage drop caused by the transparent electrodes 11a and 12a which have a high resistance.

According to an embodiment of the present invention, each of the electrode pairs may be comprised of the bus electrodes 11b and 12b only. In this case, the manufacturing cost of the PDP can be reduced by not using the transparent electrodes 11a and 12a. The bus electrodes 11b and 12b may be formed of various materials other than those set forth herein, e.g., a photosensitive material.

Black matrices are disposed on the upper substrate 10. The black matrices perform a light shied function by absorbing external light incident upon the upper substrate 10 so that light reflection can be reduced. In addition, the black matrices enhance the purity and contrast of the upper substrate 10.

In detail, the black matrices include a first black matrix 15 which overlaps a plurality of barrier ribs 21, a second black matrix 11c which is formed between the transparent electrode 11a and the bus electrode 11b of each of the scan electrodes 11, and a second black matrix 12c which is formed between the transparent electrode 12a and the bus electrode 12b. The first black matrix 15 and the second black matrices 11c and 12c, which can also be referred to as black layers or black electrode layers, may be formed at the same time and may be physically connected. Alteratively, the first black matrix 15 and the second black matrices 11c and 12c may not be formed at the same time, and may not be physically connected.

If the first black matrix 15 and the second black matrices 11c and 12c are physically connected, the first black matrix 15 and the second black matrices 11c and 12c may be formed of the same material. On the other hand, if the first black matrix 15 and the second black matrices 11c and 12c are physically separated, the first black matrix 15 and the second black matrices 11c and 12c may be formed of different materials.

An upper dielectric layer 13 and a passivation layer 14 are deposited on the upper substrate 10 on which the scan electrodes 11 and the sustain electrodes 12 are formed in parallel with one other. Charged particles generated as a result of a discharge accumulate in the upper dielectric layer 13. The upper dielectric layer 13 may protect the electrode pairs. The passivation layer 14 protects the upper dielectric layer 13 from sputtering of the charged particles and enhances the discharge of secondary electrons.

The address electrodes 22 are formed and intersects the scan electrode 11 and the sustain electrodes 12. A lower dielectric layer 24 and the barrier ribs 21 are formed on the lower substrate 20 on which the address electrodes 22 are formed.

A phosphor layer 23 is formed on the lower dielectric layer 24 and the barrier ribs 21. The barrier ribs 21 include a plurality of vertical barrier ribs 21 a and a plurality of horizontal barrier ribs 21b that form a closed-type barrier rib structure. The barrier ribs 21 define a plurality of discharge cells and prevent ultraviolet (UV) rays and visible rays generated by a discharge from leaking into the discharge cells.

The present invention can be applied to various barrier rib structures, other than that set forth herein. For example, the present invention can be applied to a differential barrier rib structure in which the height of vertical barrier ribs 21a is different from the height of horizontal barrier ribs 21b, a channel-type barrier rib structure in which a channel that can be used as an exhaust passage is formed in at least one vertical or horizontal barrier rib 21a or 21b, and a hollow-type barrier rib structure in which a hollow is formed in at least one vertical or horizontal barrier rib 21a or 21b. In the differential barrier rib structure, the height of horizontal barrier ribs 21b may be greater than the height of vertical barrier ribs 21a. In the channel-type barrier rib structure or the hollow-type barrier rib structure, a channel or a hollow may be formed in at least one horizontal barrier rib 21b.

According to an embodiment of the present embodiment, red (R), green (G), and blue (B) discharge cells are arranged in a straight line. However, the present invention is not restricted to this. For example, R, G, and B discharge cells may be arranged as a triangle or a delta. Alternatively, R, G, and B discharge cells may be arranged as a polygon such as a rectangle, a pentagon, or a hexagon.

The phosphor layer 23 is excited by UV rays that are generated upon a gas discharge. As a result, the phosphor layer 23 generates one of R, G, and B rays. A discharge space is provided between the upper and lower substrates 10 and 20 and the barrier ribs 21. A mixture of inert gases, e.g., a mixture of helium (He) and xenon (Xe), a mixture of neon (Ne) and Xe, or a mixture of He, Ne, and Xe is injected into the discharge space.

Referring to FIG. 1, a filter 100 may be disposed at the front of the PDP. An anti-reflection (AR) layer, a near infrared (NIR) shield sheet or an electromagnetic interference (EMI) shield sheet may be attached onto the filter 100.

An AR layer prevents the reflection of external light and can thus reduce glare. A NIR shield layer shields NIR rays emitted from a PDP and can thus enable IR signals, which are signals that are transmitted via, for example, a remote control using IR rays, to be smoothly transmitted.

An EMI shield layer shields EMI emitted from a PDP.

An EMI shield layer may be formed of a conductive material as a mesh. In order to properly ground an EMI shield layer, an invalid display area on a PDP where no images are displayed may be covered with a conductive material.

An external light source is generally located over the head of a user regardless of an indoor or outdoor environment. A number of external light shield patterns may be formed in the upper substrate 10 or in the upper dielectric layer 13 so that external light can be effectively shielded, and that black images can be rendered even blacker by a PDP.

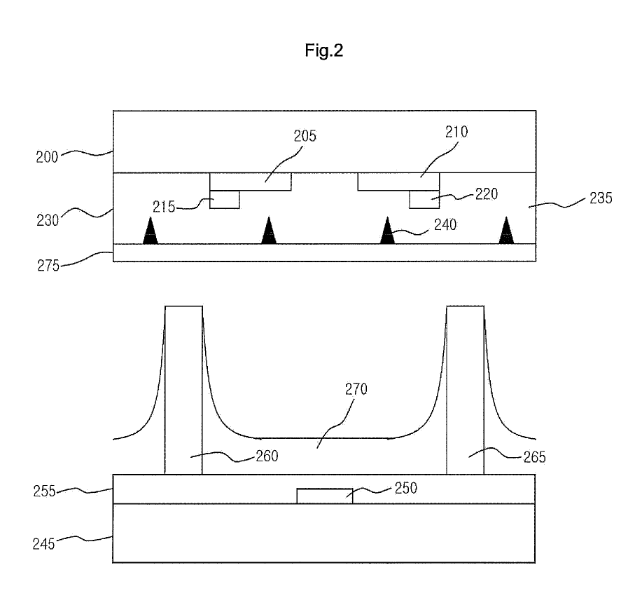

FIG. 2 is a cross-sectional view of a PDP having a plurality of external light shield patterns 240, according to an embodiment of the present invention. Referring to FIG. 2, the external light shield patterns 240 are formed in an upper dielectric layer 230.

More specifically, a sustain electrode pair consisting of a scan electrode and a sustain electrode is formed on the upper substrate 200. The sustain electrode pair includes ITO transparent electrodes 205 and 210 and bus electrodes 215 and 220. An address electrode 250, a lower dielectric layer 255, barrier ribs 260 and 265, and a phosphor layer 270 are formed on a lower substrate 245. The barrier ribs 260 and 265 define a plurality of discharge cells.

The upper dielectric layer 230 includes a base unit 245 and the external light shield patterns 240.

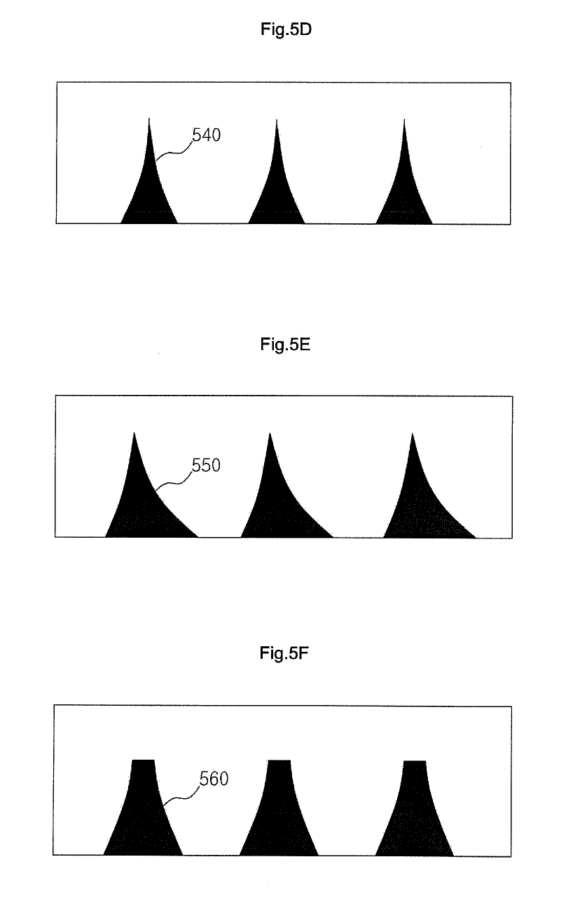

In order to enhance the absorption of external light, the external light shield patterns 240 may be formed of a black ceramic material. The external light shield patterns 240 are illustrated in FIG. 2 as being triangular. However, the present invention is not restricted to this. In other words, the external light shield patterns 240 may be formed in various shapes, other than a triangular shape, and this will be described later in further detail with reference to FIGS. 5A through 5F.

The external light shield patterns 240 may be formed in the upper dielectric layer 230 using a print method or a lamination method such as a green sheet lamination method.

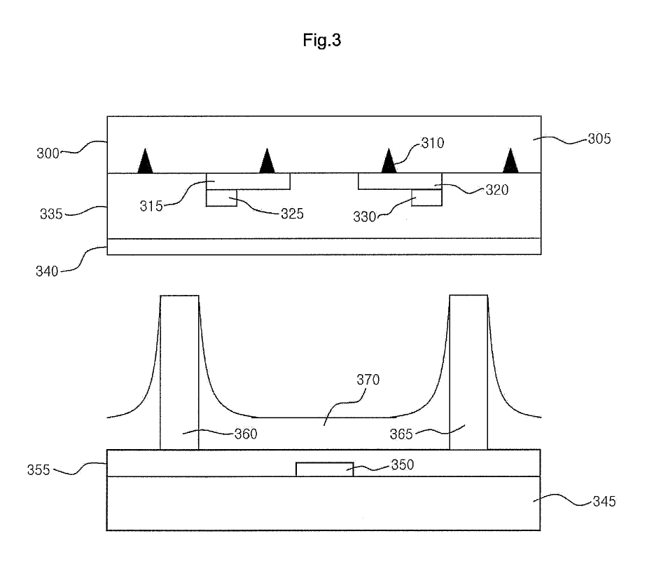

FIG. 3 is a cross-sectional view of a PDP having a plurality of external light shield patterns 310, according to another embodiment of the present invention. Referring to FIG. 3, the external light shield patterns 310 are formed in an upper substrate 300.

More specifically, a sustain electrode pair that consists of a scan electrode and a sustain electrode is formed on an upper substrate 300. The sustain electrode pair includes ITO transparent electrodes 315 and 320 and bus electrodes 325 and 330. An address electrode 350, a lower dielectric layer 355, and barrier ribs 360 and 365 that define a plurality of discharge cells, and a phosphor layer 370 are formed on a lower substrate 345.

A plurality of external light shield patterns 310 are formed in the upper substrate 300. The upper substrate 300 includes a base unit 305 which is formed of glass and the external light shield patterns 310. In order to increase the absorption of external light, the external light shield patterns 310 may be formed of a black ceramic material.

The external light shield patterns 310 may be formed in the upper substrate 300 by forming a plurality of grooves in the base unit 305 through etching and filling the grooves with a black organic or inorganic material.

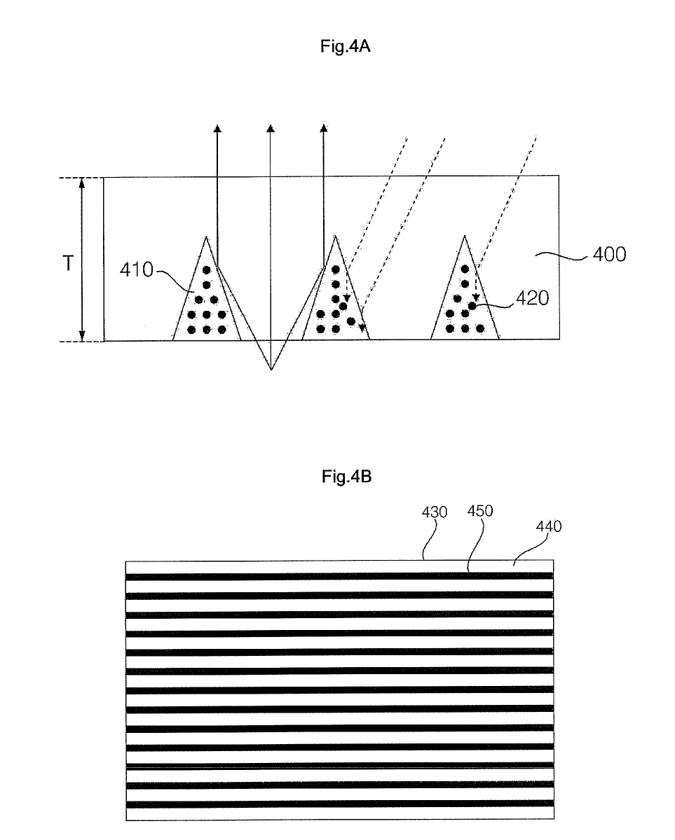

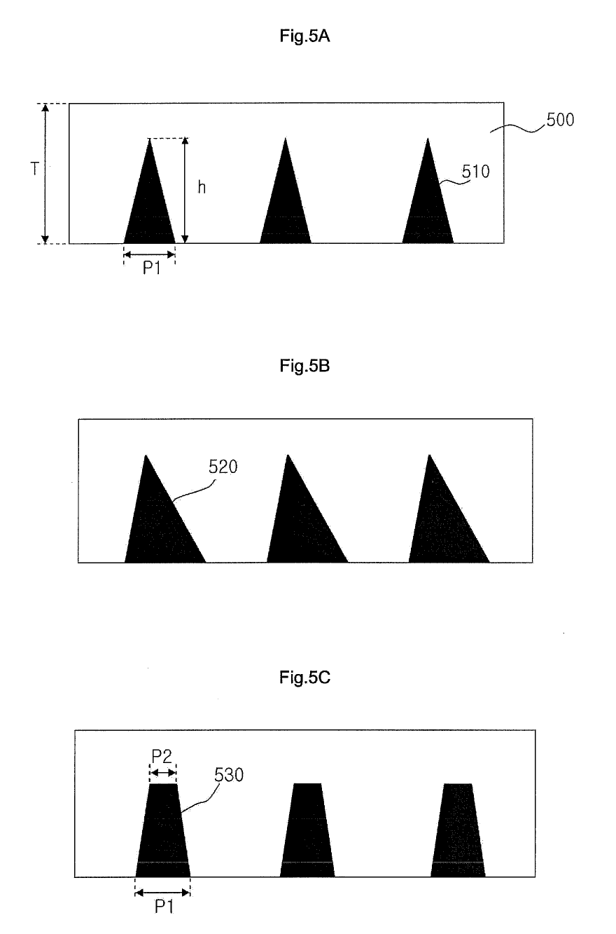

FIGS. 4A and 4B illustrate external light shield patterns that can be formed on a PDP, according to an embodiment of the present invention.

Referring to FIG. 4A, if a plurality of external light shield patterns 410 are formed in an upper dielectric layer, a base unit 400 may include a dielectric material. On the other hand, if the external light shield patterns 410 are formed in an upper substrate, the external light shield patterns 410 maybe formed of glass.

Referring to FIG. 4A, the external light shield patterns 410 are triangular, but the present invention is not restricted to this. In other words, the external light shield patterns 410 may be formed in various shapes, other than a triangular shape. The external light shield patterns 410 may be formed of a darker material (particularly, a black material) than the base unit 400. For example, the external light shield patterns 410 may be formed of a carbon-based material or may be dyed black so that the absorption of external light can be maximized.

Referring to FIG. 4A, each of the external light shield patterns 410 may contain light absorption particles 420. The light absorption particles 420 may be stained resin particles. In order to maximize the absorption of light, the light absorption particles 420 may be stained black.

The light absorption particles 420 may have a size of 1 μm or more. In this case, it is possible to facilitate the manufacture of the light absorption particles 420 and the insertion of the light absorption particles 420 into the external light shield patterns 410 and to maximize the absorption of external light. If the light absorption particles 420 have a size of 1 μm or more, each of the external light shield patterns 410 may contain 10 weight % or more of light absorption particles 420, thereby effectively absorbing external light refracted into the external light shield patterns 410.

The light absorption particles 420 may be circular, as illustrated in FIG. 4A. In this case, the light absorption particles 420 may have a diameter of 1 μm or more. However, the light absorption particles 420 may be formed in various shapes, other than a circular shape, for various reasons. In this case, the diameter of an inscribed circle of each of the light absorption particles 420 may be 1 μm or more.

A refractive index of the external light shield patterns 410, particularly, a refractive index of the slanted surfaces of the external light shield patterns 410, may be lower than a refractive index of the base unit 400. External light which reduces the bright room contrast of a PDP is highly likely to be incident upon a PDP from above. Referring to FIG. 4A, according to Snell's law, external light that is diagonally incident upon the external light shielding sheet, as indicated by dotted lines, is refracted into and absorbed by the external light shield patterns 410 which have a lower refractive index than a base unit 400. External light refracted into the external light shield patterns 410 may be absorbed by the light absorption particles 420 in the external light shield patterns 410.

Referring to FIG. 4A, light (hereinafter referred to as panel light) emitted from a PDP for displaying an image is totally reflected toward a viewer by the slanted surfaces of the external light shield patterns 410, as indicated by solid lines.

Since the angle between panel light and the slanted surfaces of the external light shield patterns 410 is greater than the angle between external light and the slanted surfaces of the external light shield patterns 410, external light is refracted into and absorbed by the external light shield patterns 410, and panel light is totally reflected by the external light shield patterns 410.

In short, the external light shield patterns 410 can absorb external light so that external light can be prevented from being reflected toward a viewer. In addition, the external light shield patterns 410 can enhance the reflection of panel light so that the bright room contrast of images displayed by the PDP can be increased.

The refractive index of the external light shield patterns 410 may be 0.3-0.99 times higher than the refractive index of the base unit 400. In this case, it is possible to maximize the absorption of external light and the total reflection of panel light in consideration of the angle at which external light is incident upon a PDP.

When the refractive index of the patterns 410 is lower than the refractive index of the base unit 400, light emitted from a PDP is reflected by the surfaces of the patterns 410 and thus spreads out toward the user, thereby resulting in unclear, blurry images, i.e., a ghost phenomenon.

When the refractive index of the patterns 410 is higher than the refractive index of the base unit 400, external light incident upon the patterns 410 and light emitted from a PDP are both absorbed by the patterns 410. Therefore, it is possible to reduce the probability of occurrence of the ghost phenomenon.

In order to absorb as much panel light as possible and thus to prevent the ghost phenomenon, the refractive index of the patterns 410 may be 0.05 or more higher than the refractive index of the base unit 400.

When the refractive index of the patterns 410 is higher than the refractive index of the base unit 400, the transmissivity and contrast of an external light shield sheet may decrease. In order not to considerably reduce the transmissivity and contrast of an external light shield sheet while preventing the ghost phenomenon, the refractive index of the patterns 410 may be 0.05-0.3 higher than the refractive index of the base unit 400. Also, in order to uniformly maintain the contrast of a PDP while preventing the ghost phenomenon, the refractive index of the patterns 410 may be 1.0-1.3 times greater than the refractive index of the base unit 420.

A thickness T of the base unit 400 may be 20-250 μm. In this case, it is possible to facilitate the manufacture of an external light shield sheet and optimize the transmissivity of an external light shied sheet. In particular, the thickness T may be 200-210 μm. In this case, it is possible to facilitate the transmission of panel light and to effectively absorb and shield external light.

FIG. 4B is a plan view of a plurality of external light shield patterns 450 according to an embodiment of the present invention. Referring to FIG. 4B, the external light shield patterns 450 may be formed in an upper dielectric layer or an upper substrate 430 as stripes. In order to prevent the moire phenomenon, the external light shield patterns 450 may be arranged diagonally with respect to the lengthwise direction of the base unit 440.

FIGS. 2 and 3 illustrate the situation when the bottoms of patterns 240, 310 faces toward a PDP. But the bottoms of patterns 240, 310 may face toward a user, and the tops of patterns 240, 310 may face toward a PDP. In this case, external light is absorbed by the bottoms of the patterns 240, 310, thereby enhancing the shielding of external light. The distance between a pair of adjacent patterns may be widened compared to the distance between a pair of adjacent patterns. Therefore, it is possible to enhance the aperture ratio of an external light shield sheet.

FIGS. 5A through 5F are cross-sectional views of various shapes of external light shield patterns according to embodiments of the present invention.

Referring to FIG. 5A, a plurality of external light shield patterns 510 may be formed in a base unit 500 as triangles, and particularly, equilateral triangles. A bottom width of the external light shield patterns 510 maybe 5-150 μg. In this case, it is possible to secure a sufficient aperture ratio to smoothly emit panel light toward a viewer.

A height h of the base unit 500 may be 30-250 μm. The slopes of the slanted surfaces of the external light shield patterns 530 may be appropriately determined in consideration of the relationship between the bottom width P1 and the height h so that the absorption of external light and the reflection of panel light can be maximized

Referring to FIG. 5B, a plurality of external light shield patterns 520 may be asymmetrical with respect to their respective horizontal axes. In other words, a pair of slanted surfaces of each of the external light shield patterns 520 may have different areas or may form different angles with the bottom of an external light shield sheet.

Referring to FIG. 5C, a plurality of external light shield patterns 530 may be trapezoidal. In this case, a top width P2 of the external light shield patterns 530 is less than a bottom width P1 of the external light shield patterns 530. The top width P2 may be 130 μm or less. The slopes of the slanted surfaces of the external light shield patterns 530 may be appropriately determined in consideration of the relationship between the bottom width P1 and the top width P2 so that the absorption of external light and the reflection of panel light can be maximized.

External light shield patterns 540, 550, and 560 illustrated in FIG. 5D, 5E, and 5F have the same shapes as the external light shield patterns 510, 520, and 530, respectively, illustrated in FIGS. 5A, 5B, and 5C except that the external light shield patterns 540, 550, and 560 have curved lateral surfaces. According to an embodiment of the present invention, each of a plurality of external light shield patterns may have a curved top or bottom surface.

In order to prevent external light shield patterns from being detached from a base unit due to external impact such as heat or pressure, the external light shield patterns may be formed to have curved edges with a predetermined curvature.

As described above, according to the present invention, a number of external light shield patterns are formed in an upper substrate or an upper dielectric layer of a PDP. Therefore, it is possible to effectively realize black images and improve the bright room contrast of a PDP.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel (PDP), comprising:
an upper substrate on which first and second electrodes and a dielectric layer are disposed; and
a lower substrate on which a third electrode is formed,
wherein the dielectric layer comprises a base unit and a plurality of pattern units which are formed in the base unit.

2. The PDP of claim 1, wherein a refractive index of the pattern units is 0.3-0.99 times higher than a refractive index of the base unit.

3. The PDP of claim 1, wherein a refractive index of the pattern units is higher than a refractive index of the base unit.

4. The PDP of claim 1, wherein a refractive index of the pattern units is 1.0-1.3 times higher than a refractive index of the base unit.

5. The PDP of claim 1, wherein the pattern units comprise light absorption particles.

6. The PDP of claim 1, wherein the base unit comprises a dielectric material.

7. The PDP of claim 1, wherein the pattern units comprise a black ceramic material.

8. The PDP of claim 1, wherein a bottom width of the pattern units is greater than a top width of the pattern units.

9. The PDP of claim 1, wherein the pattern units have a bottom width of 5-150 μm.

10. The PDP of claim 1, wherein the pattern units have a height of 30-250 μm.

11. A PDP, comprising:
an upper substrate;
first and second electrodes which are disposed on the upper substrate;
a lower substrate; and
a third electrode which is disposed on the lower substrate,
wherein the upper substrate comprises a base unit and a plurality of pattern units which are formed in the base unit.

12. The PDP of claim 11, wherein a refractive index of the pattern units is 0.3-0.99 times higher than a refractive index of the base unit.

13. The PDP of claim 11, wherein a refractive index of the pattern units is higher than a refractive index of the base unit.

14. The PDP of claim 11, wherein a refractive index of the pattern units is 1.0-1.3 times higher than a refractive index of the base unit.

15. The PDP of claim 11, wherein the pattern units comprise light absorption particles.

16. The PDP of claim 11, wherein the base unit comprises a dielectric material.

17. The PDP of claim 11, wherein the pattern units comprise a black ceramic material.

18. The PDP of claim 11, wherein a bottom width of the pattern units is greater than a top width of the pattern units.

19. The PDP of claim 11, wherein the pattern units have a top width of 130 μm or less.

20. The PDP of claim 11, wherein the pattern units have a height of 30-250 μm.
